(19) United States
(12) Patent Application Publication
(10) Pub. No.: US 2010/0267882 A1
(43) Pub. Date: Oct. 21, 2010

(54) Polyolefin Compositions

(75) Inventors: Ellen CLUNK, Cleveland, OH (US); Toru FUKADA, Sidney, OH (US)

Correspondence Address: BUCHANAN, INGERSOLL & ROONEY PC, POST OFFICE BOX 1404, ALEXANDRIA, VA, 22313-1404, US

(73) Assignee: ADVANCED COMPOSITES, INC., Sidney, OH (US)

(21) Appl. No.: 12/385,650

(22) Filed: Apr. 15, 2009

(51) Int. Cl. C08L 23/04; C08K 3/34

(52) U.S. Cl. 524/445; 525/240

(57) ABSTRACT

A composition is disclosed having: a first component of one or more of: (a) an ethylene octene rubber; (b) an ethylene butene rubber; and/or (c) a hydrogenated styrenic thermoplastic elastomer; and a second component of: (d) a surface modified nanoclay. Related articles, compositions and methods are also described.

### FIELD

The present invention is directed to polyolefin compositions and related articles and methods.

### BACKGROUND

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

Polypropylene has been used in many applications in the form of molded articles, film, sheet, etc., because it is excellent in molding processability, toughness, moisture resistance, gasoline resistance, chemical resistance, and has a low specific gravity. However, polypropylene has poor dimensional stability. This deficiency is an obstacle to utilizing such materials in certain applications, particularly in applications in which plastics have not been used. In order to overcome this shortcoming, polypropylene has been blended with different rubbers such as ethylene-octene copolymer, ethylene-butene copolymer, and styrene/butadiene block copolymer and talc. Although this decreases the coefficient of linear thermal expansion it is not decreased enough for use in certain applications, such as automotive parts.

### Definitions

Unless specifically defined herein, all technical and scientific terms have the same meaning as commonly understood by one of ordinary skill in the pertinent art. Also, all publications, patent application publications, and patents identified herein are incorporated by reference in their entirety.

As used herein, unless otherwise indicated, the term “nanoclay” includes a clay from the smectite family featuring at least one dimension at the nanometer scale.

As used herein, unless otherwise indicated, the term “surface modified” includes a surface modified or treated using quaternary amonium, or similar substance(s), that enhances the compatibility of the surface with a polymer (e.g., a resin).

### SUMMARY

The present invention includes material compositions, also referred to herein as masterbatch compositions, that optionally possess or impart one or more of the following features, benefits or advantages: excellent in molding processability, toughness, moisture resistance, gasoline resistance, chemical resistance, a low specific gravity; high dimensional stability, and a low linear coefficient of thermal expansion.

Thus, according to one aspect, the present invention provides a composition comprising: a first component comprising one or more of: (a) about 10 to about 70 weight % of an ethylene octene rubber; (b) about 10 to about 70 weight % of an ethylene butene rubber; or (c) about 10 to about 70 weight % of a hydrogenated styrenic thermoplastic elastomer; and a second component, the second component comprising: (d) about 3 to about 25 weight % of a surface modified nanoclay. The nanoclay can comprise a montmorillonite nanoclay. The first component may consist essentially of (a), (b) and/or (c), and the second component may consist essential of (d). Optionally, the first component may consist of (a), (b) and/or (c), and the second component may consist of (d). Unless otherwise noted herein, the percentages of the various constituents are based on the total weight of the composition or masterbatch.

According to a further aspect, the present invention provides a composition comprising: a first component comprising one or more of: (a) an ethylene octene rubber having a melt flow rate, measured at 190° C. under 2.16 kg load, of about 1 to about 35 dg/minutes; (b) ethylene butene rubber having a melt flow rate, measured at 190° C. under 2.16 kg load, of about 0.1 to about 40 dg/minutes; or (c) a hydrogenated styrenic thermoplastic elastomer having a melt flow rate at 230° C. under a 2.16-kg load ranges of about 2 to 15 dg/minutes; and a second component, the second component comprising: (d) a surface modified nanoclay. The melt flow rate is measured in accordance with the current ASTM D1238 standard. The nanoclay can comprise a montmorillonite nanoclay. The first component may consist essentially of (a), (b) and/or (c), and the second component may consist essential of (d). Optionally, the first component may consist of (a), (b) and/or (c), and the second component may consist of (d).

According to the present invention, the compositions described herein may be combined with one or more other materials, such as polypropylene or another thermoplastics. In addition, the present invention includes articles formed at least in part from the compositions described herein. According to the present invention, additional components may be added to directly to the compositions of the present invention, or to the combination of the compositions of the present invention and one or more thermoplastic(s). These additional components may include: fillers, pigments, phosphite-based heat stabilizers, mid-molecular tertiary amine type hindered amine light stabilizers, and high molecular weight hindered phenolic antioxidants.

### DETAILED DESCRIPTION

According to certain embodiments, the present invention relates to nanoclay and polyolefin rubber and/or thermoplastic compositions.

According to certain embodiments, these compositions may provide or impart improved dimensional stability relative to conventional polyolefin compositions. According to certain non-limiting examples, the invention can comprise a composition containing a nanoclay and one or more of a ethylene-octene copolymer rubber, a ethylene-butene copolymer rubber, and/or a hydrogenated styrene/butadiene block copolymer. When the compositions of the present invention are used as a masterbatch composition in combination with a polyolefin, the coefficient of linear thermal expansion is reduced in injection-molded articles formed therefrom, such as exterior automotive body panels.

According to certain aspects, the invention relates to compositions. Such compositions may include a first component(s) comprising one or more of: (a) an ethylene-octene rubber which may have a melt flow rate at 190° C. under a 2.16-kg load of about 1 to about 35 dg/minutes and which may have a density of about 0.865 to about 0.875 g/cc; (b) an ethylene-butene rubber which may have a melt flow rate at 190° C. under a 2.16-kg load of about 0.1 to about 40 dg/minutes and may have a density of about 0.86 to about 0.9 g/cc; and (c) a hydrogenated styrenic thermoplastic elastomer which may have a melt flow rate at 230° C. under a 2.16-kg load of about 2 to about 15 dg/minutes. The composition may also include a second component (d) comprising a surface modified nanoclay. The nanoclay can comprise a montmorillonite nanoclay. The first component may consist essentially of (a), (b) and/or (c), and the second component may consist essential of (d). Optionally, the first component may consist of (a), (b) and/or (c), and the second component may consist of (d).

Constituent (a) may be present in the composition, or a masterbatch, in an amount of about 10 to about 70 weight %. Constituent (b) may be present in the composition in an amount of about 10 to about 70 weight %. Constituent (c) may be present in the composition in an amount of about 10 to about 70 weight %. The second component (d) may be present in the composition in an amount of about 3 to about 25 weight %.

In a second embodiment, the invention relates to the use of the above-described composition or masterbatch to reduce the coefficient of linear thermal expansion of a thermoplastic material, such as a polyolefin.

This invention may also relate to compositions that contain one or more of: (a) an ethylene octene rubber; (b) an ethylene butene rubber; and (c) a styrene/butadiene block copolymer, and (d) surface modified nanoclay. When the compositions of the present invention are added to a thermoplastic material, possibly with other additives, the composition improves the dimensional stability, specifically the coefficient of linear thermal expansion of the thermoplastic material. This property is desirable in molded articles, such as molded parts used on the exterior body of automobiles.

The addition of nanoclay constituent (d) to constituents (a)-(c) reduces the coefficient of linear thermal expansion by improving the rigidity of the constituents (a)-(c). The amount of nanoclay constituent (d) is chosen to be optionally high enough to achieve sufficient rigidity but low enough that the impact resistance of the final thermoplastic product does not decline. The nanoclay can comprise a montmorillonite nanoclay.

In one embodiment, the present invention comprises a thermoplastic material, such as a polyolefin, combined with a composition or masterbatch comprising at least one of: an ethylene-octene rubber constituent (a) optionally in an amount of about 10 to about 70 weight %; an ethylene-butene constituent (b) optionally in an amount of about 10 to about 70 weight %, and a styrene butadiene rubber constituent (c) optionally present in an amount of about 10 to about 70 weight %. The composition may further comprise a nanoclay (d). The amount of nanoclay constituent (d) optionally is about 3 to about 25 weight %. According to further embodiments, the amount of constituent (a) is about 30 to about 50 weight %, and/or the amount of constituent (b) ranges from about 30 to about 50 weight %; and/or the amount of constituent (c) is about 30 to about 50 weight %; and amount of constituent (d) is about 5 to about 15 weight %. According to additional alternative embodiments, the amount of constituent (a) is about 42 weight %, the amount of constituent (b) is about 42 weight %, and/or the amount of constituent (c) is about 46 weight %; and the amount of constituent (d) is about 6%. The total weight percentage of the composition is 100 weight %.

According to further optional embodiments, the composition comprises at least one of: ethylene-octene rubber, constituent (a), and an ethylene-butene rubber (b).

The constituent (a) may optionally have (i) an ethylene content of about 55 to about 65 weight %; and/or (ii) a melt flow rate at 190° C. under a 2.16-kg load of about 1.0 to about 35 dg/minutes, and/or (iii), a density of about 0.860 to about 0.875 g/cc.

The ethylene content, criteria (i) can be high enough to retain good impact strength in the final material, but low enough not to impair rigidity. Specifically, the ethylene content can range from about 55 to about 65 weight %. Optionally, the ethylene content can be about 58 to about 62 weight %, or the ethylene content can be about 60 weight %.

The melt flow rate, criteria (ii) of constituent (a), can be high enough to provide superior orientation in the final material. Specifically, the melt flow rate of constituent (a) can be about 1.0 to about 35 dg/minutes at 190° C. under a 2.16-kg load. Optionally, the melt flow rate is about 5 to about 35 dg/minutes, or is optionally about 30 dg/minutes.

The density of the ethylene octene rubber, criteria (iii), can be high enough to allow sufficient heat resistances and low enough to retain good impact strength in the final thermoplastic material. The density of the ethylene octene rubber may optionally be about 0.860 to about 0.875 g/cc. According to further alternatives, the density can be about 0.864 to about 0.872 g/cc, or the density can be about 0.87 g/cc.

The constituent (b) may have (i) an ethylene content of about 65 to about 75 weight %; and/or (ii) and/or flow rate at 190° C. under a 2.16-kg load ranges of about 0.1 to about 40 dg/minutes, and/or (iii), a density of about 0.860 to about 0.89 g/cc.

The ethylene content, criteria (i) can be high enough to retain good impact strength in the final thermoplastic material composition but low enough not to impair rigidity. Specifically, the ethylene content can be about 65 to about 75 weight %. Optionally, the ethylene content can be about 65 to about 70 weight %, or, the ethylene content can be about 67 weight %.

The melt flow rate, criteria (ii) of constituent (b), can be high enough to provide superior orientation in the final material. Specifically, the melt flow rate of constituent (a) can be about 0.1 to about 40 dg/minutes at 190° C. under a 2.16-kg load. Optionally, the melt flow rate is about 3 to about 35 dg/minutes, or optionally is about 35 dg/minutes.

The density of the ethylene butene rubber, criteria (iii), can be high enough to allow from sufficient heat resistances and low enough to retain good impact strength in a final thermoplastic material. The density of the ethylene octene rubber can be about 0.860 to about 0.89 g/cc. Optionally, the density is about 0.864 to about 0.872 g/cc, or the density is about 0.864 g/cc.

In addition to, or in the place of constituents (a) and/or (b), the composition may comprise a hydrogenated styrene/butadiene block copolymer constituent (c). Constituent (c) may have a melt flow rate which provides better orientation in a final thermoplastic material. Specifically, the flow rate of the styrene/butadiene copolymer can be about 2 to about 15 dg/minutes at 230° C. under a 2.16-kg load. Optionally, the melt flow rate can be about 4 to about 6 dg/10 minutes, or the melt flow rate can be about 4.5 dg/minutes, also at 230° C. under a 2.16-kg load.

The constituents of the masterbatch may be blended or mixed together using methods known in the art to prepare thermoplastic resin compositions. Preferably, the constituents are blended together to form a blended composition and then pelletized.

The blending step may be performed by any method known in the art. The blending step should, at least minimally, disperse the constituents amongst each other. Optionally, all constituents, are blended together in one step. The blending can be performed, according to one non-limiting example, by twin-screw extrusion.

The following examples illustrate exemplary compositions or masterbatches of the invention when compounded into a thermoplastic material. The scope of the invention is not to be limited by these examples.

### EXAMPLES

### Example 1

The following constituents were blended together: 94 weight % of an ethylene octene rubber, having a melt flow rate of 1.0 dg/10 minutes and a density of 0.87 g/cc; and 6 weight % of nanoclay. The blended masterbatch composition was then extruded and pelletized. The pelletized masterbatch composition is then blended and extruded with remaining constituents of the final thermoplastic material. The remaining constituents are: polypropylene; hydrogenated styrene/butadiene; and talc. Four polypropylene materials were combined to form the polypropylene constituent of the final composition: T171200M, T15900C, T15350C and F100HC; all commercially available from Sunoco. The total amount of polypropylene in the overall final thermoplastic composition is 45.5% by weight. The styrene/butadiene constituent is Tuftec™ H106, commercially available from Asahi Kasei, and constitutes 12% by weight of the total material composition. The talc constituent was Flex405D commercially available from Specialty Minerals, and constitutes 31.5% by weight of the overall material composition. The masterbatch composition described above constituted the balance of the overall material composition.

### Example 2

Example 2 was conducted under the same conditions and used the same materials as Example 1, except the ethylene octene rubber has a melt flow rate of 15 dg/10 minutes and a density of 0.865 g/cc.

### Example 3

Example 3 was conducted under the same conditions and used the same materials as Example 1, except the ethylene octene rubber has a melt flow rate of 30 dg/10 minutes and a density of 0.87 g/cc.

### Example 4

The following constituents were blended together: 94 weight % of an hydrogenated styrene/butadiene, having a melt flow rate of 4.5 dg/10 minutes; and (b) 6 weight % of nanoclay. The blended composition was then extruded and pelletized. The pelletized composition is then blended and extruded with the remaining constituents of the thermoplastic masterbatch composition: polypropylene; ethylene octene rubber; and talc. Four polypropylene materials were combined to form the polypropylene constituent of the final composition: TI171200M, T15900C, TI5350C and F100HC; all commercially available from Sunoco. The total amount of polypropylene in the overall final thermoplastic composition is 45.5% by weight. The ethylene octene rubber constituent was Engage™ 8100 commercially available from DuPont-Dow, which constituted 11% by weight of the final material composition. The talc constituent was Flex405D commercially available from Specialty Minerals, and constitutes 31.5% by weight of the overall material composition. The masterbatch composition described above constituted the balance of the overall material composition.

### Example 5

Example 5 was conducted under the same conditions and used the same materials as Example 1, except the ethylene octene rubber content is 88 weight % and the nanoclay content is 12 weight %.

### Example 6

Example 6 was conducted under the same conditions and used the same materials as Example 2, except the ethylene octene rubber content is 88 weight % and the nanoclay content is 12 weight %.

### Example 7

Example 7 was conducted under the same conditions and used the same materials as Example 3, except the ethylene octene rubber content is 88 weight % and the nanoclay content is 12 weight %.

Example 8

Example 8 was conducted under the same conditions and used the same materials as Example 4, except the hydrogenated styrene/butadiene content is 88 weight % and the nanoclay content is 12 weight %.

### Example 9

Example 9 was used as a control material or a comparative example which does not use the invention. Polypropylene, ethylene octene rubber, and talc were blended and extruded then pelletized. Three polypropylene materials were combined to form the polypropylene constituent of the control material composition: TI71200M, TI5900C, and F100HC; all commercially available from Sunoco. The total amount of polypropylene in the overall final thermoplastic composition is 55.5% by weight. The ethylene octene rubber constituent was a combination of two materials; Engage™ 8100, and Engage™ 8842, both commercially available from DuPont-Dow, which constituted 20% by weight of the final material composition. The ethylene butene rubber constituent was Tamfer™ A0250S, commercially available from Mitsui Chemicals, constituted 3% by weight of the overall thermoplastic material composition. The talc constituent was Flex815D, commercially available from Specialty Minerals, and constituted 21.5% by weight of the overall material composition.

Test pieces were formed using the pellets of the final thermoplastic material composition and their coefficient of linear thermal expansion was evaluated in both the material direction (MD) and the transverse direction (TD). The coefficient of linear thermal expansion was measured in conformance with ASTM E831, to evaluate the dimensional stability of the composition over a temperature range of −30° C. to 80° C. A composition having an average coefficient of linear thermal expansion of 7.55 to 6.5×10⁻⁵/° C. or lower is acceptable. A composition having a coefficient of linear thermal expansion of 6.495 to 5.5×10⁻⁵/° C. or lower maybe more beneficial in certain instances. A composition having a coefficient of linear thermal expansion of 5.1×10⁻⁵/° C. or lower may be even more advantageous in certain instances or applications. The results of the above measurements are summarized in Table I below

TABLE I

| CLTE | | | | | | | | | |
|---|---|---|---|---|---|---|---|---|---|
| (−30° C.~80° C.) | Ex. 1 | Ex. 2 | Ex. 3 | Ex. 4 | Ex. 5 | Ex. 6 | Ex. 7 | Ex. 8 | Ex. 9 |
| MD | 5.67 | 4.04 | 5.19 | 7.19 | 7.14 | 5.05 | 5.19 | 6.03 | 6.25 |
| TD | 6.91 | 6.95 | 4.99 | 7.27 | 7.8 | 8.45 | 5.59 | 9.055 | 8.54 |
| Average | 6.29 | 5.50 | 5.09 | 7.23 | 7.47 | 6.75 | 5.39 | 7.54 | 7.40 |

Any numbers expressing quantities of ingredients, constituents, reaction conditions, and so forth used in the specification are to be understood as being modified in all instances by the term “about.” Notwithstanding that the numerical ranges and parameters setting forth, the broad scope of the subject matter presented herein are approximations, the numerical values set forth are indicated as precisely as possible. Any numerical value, however, may inherently contain certain errors or inaccuracies as evident from the standard deviation found in their respective measurement techniques. None of the features recited herein should be interpreted as invoking 35 U.S.C. §112, ¶6, unless the term “means” is explicitly used.

Although the present invention has been described in connection with preferred embodiments thereof, it will be appreciated by those skilled in the art that additions, deletions, modifications, and substitutions not specifically described may be made without departing from the spirit and scope of the invention.

We claim:

1. A composition comprising:
a first component comprising one or more of:
(a) about 10 to about 70 weight % of an ethylene octene rubber;
(b) about 10 to about 70 weight % of an ethylene butene rubber; or
(c) about 10 to about 70 weight % of a hydrogenated styrenic thermoplastic elastomer; and
a second component, the second component comprising:
(d) about 3 to about 25 weight % of a surface modified nanoclay.

2. The composition of claim 1, wherein the first component comprises (a), and the ethylene octene rubber has a melt flow rate, measured at 190° C. under 2.16 kg load, of about 1 to about 35 dg/minutes.

3. The composition of claim 1, wherein the first component comprises (b), and the ethylene butene rubber has a melt flow rate, measured at 190° C. under 2.16 kg load, of about 0.1 to about 40 dg/minutes.

4. The composition of claim 1, wherein the first component comprises (c), and the hydrogenated styrenic thermoplastic elastomer has a melt flow rate at 230° C. under a 2.16 kg load of about 2 to about 15 dg/minutes.

5. The composition of claim 1, wherein the first component comprises (a) and the ethylene octene rubber has an ethylene content from about 55 to about 65 weight %.

6. The composition of claim 1, wherein the first component comprises (b) and the ethylene butene rubber has an ethylene content from about 65 to about 75 weight %.

7. The composition of claim 1, wherein the first component comprises (a) and the ethylene octene rubber a density of about 0.860 to about 0.875 g/cc.

8. The composition of claim 1, wherein the first component comprises (b) and the ethylene butene rubber has a density of about 0.860 to about 0.89 g/cc.

9. The composition of claim 1, wherein the first component consists essentially of at least one of (a), (b), or (c), and the second component consists essentially of (d).

10. The composition of claim 1, wherein the first component consists of at least one of (a), (b), or (c), and the second component consists of (d).

11. A composition comprising:
a first component comprising one or more of:
(a) an ethylene octene rubber having a melt flow rate, measured at 190° C. under 2.16 kg load, ranging from about 1 to about 35 dg/minutes;
(b) ethylene butene rubber having a melt flow rate, measured at 190° C. under 2.16 kg load, ranging from about 0.1 to about 40 dg/minutes; or
(c) a hydrogenated styrenic thermoplastic elastomer having a melt flow rate at 230° C. under a 2.16 kg load ranges from about 2 to about 15 dg/minutes; and
a second component, the second component comprising:
(d) a surface modified nanoclay.

12. The composition of claim 11, wherein at least one of (a), (b) and (c) is present in an amount of about 10 to about 70 weight %.

13. The composition of claim 12, wherein (d) is present in an amount of about 3 to about 25 weight %.

14. The composition of claim 1, wherein the first component consists essentially of at least one of (a), (b), or (c), and the second component consists essentially of (d).

15. The composition of claim 1, wherein the first component consists of at least one of (a), (b), or (c), and the second component consists of (d).

16. An injection molded automotive body part formed at least in part from the composition of claim 1.

17. An injection molded automotive body part formed at least in part from the composition of claim 11.

18. An article formed at least on part from the composition of claim 1, the article having a coefficient of linear thermal expansion of less than about 5.1×10⁻⁵/° C.

19. An article formed at least on part from the composition of claim 11, the article having a coefficient of linear thermal expansion of less than about 5.1×10⁻⁵/° C.

20. A material comprising, in combination, a polymer and the composition of claim 1.

21. A material comprising, in combination, a polymer and the composition of claim 9.
